(19) United States
(12) Patent Application Publication
(10) Pub. No.: US 2006/0128550 A1
(43) Pub. Date: Jun. 15, 2006

(54) Method for producing borosilicate glass, borate glass and crystallising materials containing boron

(76) Inventors: Michael Leister, Budenheim (DE); Uwe Kolberg, Mainz (DE); Werner Thomas Kiefer, Mainz (DE); Sybill Nuttgens, Frankfurt (DE); Alexander Penkert, Eich (DE); Silke Wolff, Huckeswagen (DE); NIcole Surges, Bingen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/537,752

(22) PCT Filed: Dec. 2, 2003
(86) PCT No.: PCT/EP03/13576

§ 371 Date: Dec. 5, 2005

(30) Foreign Application Priority Data
Dec. 6, 2002 (DE) 10257049.3

(51) Int. Cl. C03C 3/14; C03C 3/089; C03B 5/16; C03B 5/02

(52) U.S. Cl. 501/49; 65/135.6; 65/134.5; 501/65

(57) ABSTRACT

A process for producing a borate-containing, low-alkali material is provided. The process includes induction-heating a boron-containing melting material directly in an appliance using an alternating electromagnetic field. The, melting material as a constituent includes at least one metal oxide, the metal ions of which have a valency of at least two, in a quantitative proportion of at least 25 mol %, and in which the ratio of the molar substance quantities of silicon dioxide to borate in the melting material is less than or equal to 0.5.

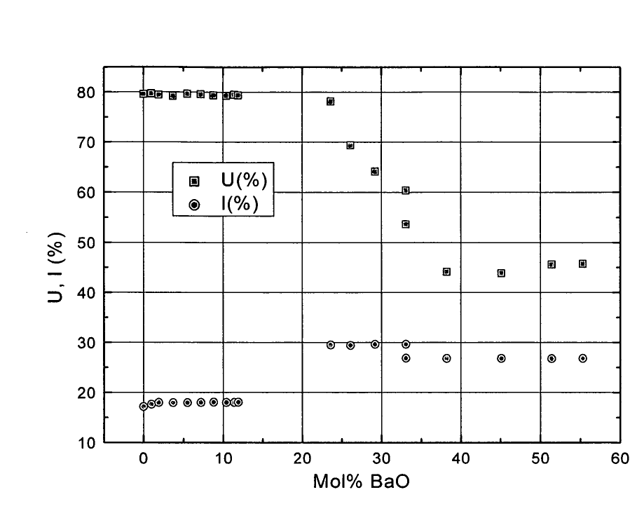

The invention relates to a process for producing boron-containing materials. In particular, the invention relates to a process for producing boron-containing, low-alkali materials by means of inductive heating of the melting material.

In technical applications, borosilicate glasses are used as laboratory glass, for ampoules in the pharmaceutical industry and as incandescent lamp glasses, on account of their good chemical resistance and their relatively low thermal expansion. These glasses have a high SiO₂ content of 73-86%, a B₂O₃ content of 6-13%, an Al₂O₃ content of 1-5% and an alkali metal content of 2-9% (mol %).

In the case of the optical glasses, the B₂O₃ content may also be over 13% and may be as much as over 75 mol %. The high B₂O₃ content results in high Abbe numbers, i.e. a low level of light scattering. These glasses are therefore used in lens systems to correct the chromatic aberration.

Glasses which contain only or predominantly B₂O₃ as networkformer agent are known as borate glasses, by analogy to silicate glasses. The borosilicate glasses contain both SiO₂ and B₂O₃ as network formers and in terms of their composition are therefore between the silicate glasses and the borate glasses.

The borosilicate glasses with a low B₂O₃ content, in particular less than 15% of B₂O₃, differ significantly from borosilicate glasses and borate glasses with a high B₂O₃ content (over 15% of B₂O₃) in terms of their physical, chemical and optical properties. For example, the borosilicate glasses with the high B₂O₃ content and the borate glasses usually have a very steep viscosity curve with a high transformation temperature T_{g} but a low working point VA and therefore low melting and refining temperatures. The optical position of these glasses lies at very high Abbe numbers, and the chemical resistance is generally much worse than in the borosilicate glasses with a low B₂O₃ content and the silicate glasses.

It is generally also the case that no alkali metal oxides, or only a few per cent of alkali metal oxides, are used in the borosilicate glasses and the borate glasses with a high B₂O₃ content, since alkali metal oxides on the one hand are not required for melting on account of the viscosity profile and on the other hand alkali metal oxides cause the chemical resistance to deteriorate still further. Also, the desired high Abbe numbers cannot be achieved with borate glasses which contain alkali metal oxides.

Glass melts for silicate glasses and borosilicate glasses with a high B₂O₃ content have the drawback of being highly chemically aggressive. In this context, reference need merely be made to boric acid digestion in chemical analysis.

Silicate glasses and borosilicate glasses with a low B₂O₃ content can be melted successfully in ceramic refractory materials. For optical applications, however, higher demands are generally imposed on the light transmission and, by association, on the purity of the glasses. Consequently, silicate glasses and borosilicate glasses with a low B₂O₃ content for optical applications are often produced in platinum vessels or in fused silica apparatus.

Unlike the silicate glasses and borosilicate glasses with a low B₂O₃ content, the borosilicate glasses and borate glasses with a high B₂O₃ content attack the fused silica equipment so strongly that SiO₂ cords can easily be formed in the glass melt. Even with intensive stirring, these SiO₂ cords can no longer be dissolved completely. A further, more critical factor is that the dissolved SiO₂ changes the properties of the borosilicate glasses and borate glasses with a high B₂O₃ content, in some cases considerably.

Further consequences of the strong attack on the refractory material, in addition to the significant deterioration in the properties and homogeneity, are very short service lives of the fused silica equipment, which entails considerable costs. Costs are incurred firstly because of the need to renew the fused silica equipment and secondly on account of the fact that production has to be constantly shut down.

However, the borosilicate glasses and borate glasses with a high B₂O₃ content attack not only the fused silica equipment but also platinum appliances. The dissolved platinum also has a considerable adverse effect on the properties of the glasses. Depending on the oxidation state of the glass melt, the glass melt contains metallic platinum particles or platinum ions. The coloring platinum ions reduce the transmission of these glasses, in particular in the ultraviolet region, to an extent which is no longer acceptable for many applications.

The strong chemical attack by the borosilicate glasses and borate glasses with a high B₂O₃ content means that these optical glasses which have been melted using standard melting processes for some applications no longer satisfy the increased technical demands relating to the transmission and homogeneity.

Furthermore, the high level of chemical attack by the glasses on the precious metal melting equipment or the ceramic melting equipment also entails considerable additional costs, which constitutes an obstacle to widespread use of these glasses.

The invention is therefore based on the object of providing a process which makes it possible to melt boron-containing, in particular borate-containing, low-alkali materials, such as for example low-alkali or even alkali-free borosilicate glasses with a high B₂O₃ content and borate glasses with a high purity and homogeneity, or low-alkali/alkali-free crystallizing borate-containing materials or batches for materials of this nature and in this way to produce the materials in a very pure form.

This object is achieved, in an extremely surprisingly simple way, by a process as described in claim 1. Advantageous refinements to the process are given in the subclaims.

Accordingly, in the process according to the invention for producing a borate-containing low-alkali material, induction heating is carried out directly in an appliance using an alternating electromagnetic field, the melting material including as a constituent at least one metal oxide, the metal ions of which have a valency of at least two, in a quantitative proportion of at least 25 mol %, and the ratio of the substance quantities of silicon dioxide to borate in the melting material being less than or equal to 0.5.

In this context, a particularly suitable alternating electromagnetic field is a high-frequency field which can be used to introduce large quantities of energy into a melt by induction.

Surprisingly, the inventors have discovered that boron-containing melts, such as in particular those formed from low-alkali or alkali-free borosilicate glasses with a high B₂O₃ content, and low-alkali or alkali-free borate glasses can have high frequency coupled to them if the B₂O₃/(B₂O₃+SiO₂) molar ratio is >0.5, i.e. if the quantitative ratio of silicon dioxide to borate in the melting material is less than or equal to 0.5.

This discovery was all the more surprising since even alkali-containing borosilicate glasses with a low B₂O₃ content, in which the molar ratio of B₂O₃/(B₂O₃+SiO₂) is <0.5, in practice cannot be coupled up or can only be coupled up at high temperatures. Factors which militate against borosilicate glasses with a high B₂O₃ content and borate glasses melting in skull crucibles heated with high-frequency electromagnetic energy are firstly the expected low ability of the low-alkali/alkali-free borosilicate glasses with a high B₂O₃ content and of the borate glasses to be coupled to alternating electromagnetic fields, and secondly the risk of the molten glass breaking through on account of the very low viscosity of these glasses with the associated risk of flashovers.

An explanation for the phenomenon whereby the melts according to the invention, contrary to expectations, can in fact be coupled to an electromagnetic high-frequency field could be that with a B₂O₃/(B₂O₃+SiO₂) molar ratio of <0.5 the SiO₂ is the dominant network former, and the B₂O₃ only determines the structure at a B₂O₃/(B₂O₃+SiO₂) molar ratio of >0.5.

It is known from the article “Inorganic Glass-Forming Systems by H. Rawson, Academic Press London and New York 1967, page 107 that aluminoborate systems have excellent electrical insulation properties. These glasses even have a higher electrical resistance than fused silica. This means that these glasses have an extremely poor electrical conductivity in the solid state. Surprisingly, however, it is found that glasses of this type, if they have a composition as given in claim 1, can nevertheless be coupled to high frequency and produced using the process according to the invention.

The direct induction heating of the melt by means of a high-frequency alternating field makes it possible to produce particularly pure materials, since there is no direct contact between the melt and the material of a heating device. Moreover, impurities, such as for example residues and combustion products, which may form during the combustion of organic fuels in the top furnace atmosphere, are avoided.

In the present context, the term coupling of the melt to the alternating electromagnetic field, such as in particular in the form of a high-frequency field, is understood as meaning that the introduction of energy into the melt by inductive coupling is greater than the discharge of energy from the melt as a result of the dissipation of heat. Therefore, heating or maintaining of the melt by high-frequency heating is only actually possible if a melt is coupled to the high-frequency field.

Silicate glasses and in particular aluminosilicate glasses with a high alkali metal content have a sufficient electrical conductivity and are therefore successfully coupled to high frequency, whereas low-alkali silicate glasses are only coupled to an alternating electromagnetic field at very high temperatures, or are not coupled to such a field at all.

In general, the electrical conductivity increases as the temperature rises. However, the glasses with a high boric acid content cannot be heated to very high temperatures, since otherwise the alkali metal borates or the boric acid evaporate to a considerable extent, meaning that the composition changes in an uncontrolled manner. This can lead, inter alia, to undesirable formation of knots.

It is to be expected that borosilicate glasses with a low B₂O₃ content, given the same alkali metal content, will already be significantly less well coupled to an electromagnetic field than will silicate glasses, since the mobility of the alkali metal ions in the glass structure is impeded by the boron oxide. This is also manifested by the fact that borosilicate glasses, in contrast to aluminosilicate glasses, are relatively unsuitable for chemical ion exchange. Accordingly, the coupling of borate glasses becomes much worse or is even no longer possible if glasses of this type contain low levels of or no alkali metals. Only the process according to the invention, surprisingly, still enables borate-containing melts to be coupled to a high-frequency field.

Surprisingly, it is found that these melts can be coupled up if borate rather than silicon oxide is the main network former, i.e. if, in the case of borosilicate glasses, the quantitative proportion of borate exceeds that of silicon oxide. In this case, it is then also possible for the alkali metal ions, which are otherwise important for sufficiently conductive coupling of the melt, to be replaced by other metal ions. It has been found that in this context a quantitative proportion of 25% of oxides with divalent or polyvalent metal ions, such as for example alkaline-earth metal oxides, is sufficient.

Low-alkali borosilicate glasses with a high boric acid content, borate glasses and crystallizing borate-containing materials are particularly suitable borate-containing materials for production using the process according to the invention.

Although the metal oxides with monovalent metals, such as in particular alkali metal oxides, considerably increase the conductivity of the glasses and therefore the coupling behavior, the quantitative proportion of compounds which contain alkali metals in the melting material, such as in particular the quantitative proportion of monovalent metal oxides, can advantageously be limited to less than or equal to 0.5%, in order to improve the physical and chemical properties of the glasses without the melt losing its coupling properties.

In this context, it should be noted that in the case of the borosilicate glasses with a high B₂O₃ content and borate glasses the coupling behavior for the melting according to the invention using high-frequency heating is better if the alkali metal content is over 0.5%. Particularly good coupling is achieved with a quantitative proportion of just 2% of compounds which contain alkali metals. The term low-alkali melt is understood as meaning in particular a melt having a quantitative proportion of alkali metal compounds of at most 2%, preferably of at most 0.5%.

In addition to the conventional ceramic crucibles or the precious metal vessels, it is in particular also possible to use a skull crucible to melt ceramics and glasses in accordance with the invention. Devices which are particularly suitable for carrying out the production process according to the invention are described, inter alia, in the earlier German Application in the name of the present Applicant, Application No. 102 44 807.8, the content of disclosure of which is hereby also incorporated in its entirety in the subject of the present invention. Suitable skull crucibles are also known, for example, from EP 0 528 025 B1.

The skull crucibles comprise a cooled crucible wall. This may, for example, be cylindrical and be composed of a ring of vertical tubes, preferably metal tubes. The cooling fluid used is preferably water. However, cooling with other cooling fluids, such as for example air or an aerosol, is also possible.

Slots remain between adjacent tubes. The crucible base may also be composed of tubes. At their ends, the tubes are connected to vertical tubes for supplying coolant and/or discharging coolant.

Heating is effected by means of an induction coil which surrounds the crucible wall and by means of which electromagnetic energy, preferably in the form of a high-frequency electromagnetic field, can be coupled into the contents of the crucible.

According to a preferred embodiment, an alternating field with a frequency in the range from 50 kHz to 1500 kHz is used for direct induction heating of the melt. In this case, it is advantageous to use the post office-approved frequencies, such as for example 386 kHz in Germany. The choice of a suitable frequency is also dependent on the capacity of the crucible used. As the frequency rises, the depth to which the field penetrates into the melt decreases. Therefore, lower frequencies tend to be advantageous for large crucibles and higher frequencies for smaller crucibles, in order to ensure a sufficiently high heating power even in the center of the crucible.

A skull crucible works substantially in the following way: the crucible is filled with batch mixture or charge cullet or a mixture of the two. The glass or glass melt must first of all be preheated in order to reach a minimum electrical conductivity of the glass melt. When the coupling temperature has been reached, the further supply of energy can be effected by the introduction of high-frequency energy.

The advantage of melting by direct induction heating in a skull crucible is that a skull layer comprising material of the same type as the batch can form at the cooled walls, such as for example walls comprising water-cooled metal tubes. This prevents the melt from coming into contact not only with a heating device but also with the crucible wall. Therefore, particularly pure materials can be melted in a crucible of this type, since there is no introduction of foreign material, such as for example coloring ions from the wall, into the melt.

The skull layer forms on the cooled tubes. Between the tubes, the glass melt penetrates some way into the space until it has been cooled sufficiently from both sides for a thin layer of glass also to be formed, closing up the gap between the tubes. If the distance between the metal tubes is too wide or if the skull layer is too thin, the skull layer may no longer be able to withstand the pressure of the glass melt, and consequently the glass will flow out between the metal tubes.

The melting with an inductively heated skull crucible is preferably used to melt crystals or high-melting glasses. When crystals are being melted, the skull layer consists of lightly sintered crystal powder, while in the case of glasses a vitreous or crystalline layer is formed.

To allow melting to be carried out using high frequency in a skull crucible, the energy which is introduced into the glass melt by the high frequency must be greater than the energy which is dissipated by radiation or dissipation of heat via the skull layer and the cooled walls of the skull crucible. This is only the case if the glass melt has a sufficient electrical conductivity and therefore a sufficiently good coupling behavior.

Borosilicate glasses with a high B₂O₃ content and borate glasses, unlike silicate glasses and borosilicate glasses with a low B₂O₃ content, have an extremely low viscosity at the melting temperature. These borosilicate glasses with a high B₂O₃ content and the borate glasses are very short. This means that the transition from the high-viscosity state to the low-viscosity state takes place within a very narrow temperature range. Therefore, at the melting temperature these glasses have a similarly low viscosity to water. At these low viscosities, it is likely that only a very thin skull layer will be formed, and this layer will be unable to withstand the weight of the melt, and consequently the melt will break through. In this context, the melt breaking through is to be understood as meaning the glass melt running out between the water-cooled metal tubes of a skull crucible.

The inventors have discovered that this outflow becomes more critical the lower the viscosity of the glass melt. It has been found that, in the case of high-melting glasses, where there is a relatively great distance between the metal tubes the melt penetrates relatively deep into the space between the metal tubes but still forms a skull layer between the metal tubes.

In the case of low-viscosity glass melts, the flow rate of the glass melt between the metal tubes may be so high that the dissipation of heat via the metal tubes is no longer sufficient to stop the flow of glass and form a skull layer.

If a skull crucible is used to melt a “short” borate-containing material, a short distance between the metal tubes of the crucible is advantageous in order to prevent the melt from breaking through. Nevertheless, a certain distance must still remain between the tubes, in order, inter alia, to prevent shielding of the high-frequency field.

A space amounting to 5 mm or less may be selected in particular for high-melting, high-viscosity melts.

It has been found that it is possible to effectively prevent in particular borosilicate glasses with a high B₂O₃ content and borate glasses from running out if the distance between the cooled tubes of the skull crucible is less than or equal to 4 mm, preferably less than or equal to 3.5 mm. The greater distance is preferably selected for more viscous glasses.

The lower the viscosity of the glass melt, the narrower the distance is advantageously selected to be.

The distances between the metal tubes cannot be reduced arbitrarily, since on the one hand this makes the skull crucible ever more difficult to produce, i.e. makes it more difficult to weld or solder the metal tubes, and on the other hand there is an increasing risk of flashovers between the metal tubes. It has been found that a distance between the metal tubes of greater than or equal to 2 mm, preferably of greater than or equal to 2.5 mm, is most favorable both for producing and for controlling the flashovers.

To enable both conditions to be satisfied, it is advantageous if the distance between the tube walls of the metal tubes is between 2 mm and 4 mm, preferably between 2.5 mm and 3.5 mm. In the case of very low-melting glasses, a distance of 2.5 mm tends to be advantageous.

Furthermore, when melting glasses, a further problem may be flashovers in the melt from one cooled metal tube to the next. The lower the insulating action of the skull layer, the greater this risk becomes. This risk is correspondingly particularly high in the case of very low-viscosity melts, on account of the thin skull layer. Particularly in the case of borosilicate glasses with a high B₂O₃ content and borate glasses, both of which generally form only thin skull layers, there is a tendency to flashovers between the metal tubes. The flashover takes place via the glass melt and the thin skull layer. The thinner the skull layer and the lower the electrical resistance of the skull layer, the greater the probability of a flashover occurring.

As has already been mentioned, the skull layer is intended not only to prevent the glass melt from running out, but also to prevent a flashover between the metal tubes via the glass melt. The thicker the skull layer and the greater the distance between the cooled metal tubes, the greater the insulating action becomes.

Tests have shown that for the glasses claimed the thickness of the skull layer and the claimed distance between the metal tubes are often insufficient to prevent a flashover via the glass melt.

However, flashovers between the metal tubes can advantageously be avoided in a simple way by the metal tubes being short-circuited in particular in the region of the induction coil for emitting the alternating electromagnetic field, such as for example a high-frequency coil. The short circuit prevents high potential differences from being able to build up between the tubes in the alternating electromagnetic field.

The inventors have also discovered that when melting in a skull crucible there is a very close relationship between the viscosity of the glass melt, the extent to which the glass melt runs out and the flashovers in the melt.

Surprisingly, it has emerged that, for a composition range of low-melting borosilicate glasses with a high B₂O₃ content and borate glasses, it is possible, during the melting according to the invention using a skull crucible, to find a range for the distance between the cooled metal tubes at which the glass melt does not yet flow out and flashovers can be prevented with the aid of additional measures.

Tests have shown that the claimed borosilicate glasses with a high B₂O₃ content and borate glasses only form a very thin skull layer and therefore have a very strong tendency for the melt to run out.

The inventors have discovered that the flashovers are dependent not only on the skull layer and the distance between the metal tubes but also on the electrical conductivity of the metal tubes used.

Particularly when using water-cooled tubes with a high electrical conductivity, for example copper tubes, one short-circuiting location is sufficient. On account of the high conductivity, it is impossible for major potential differences to build up between the tubes if they have at least one short-circuiting location or if the metal tubes are short-circuited at in each case one location.

On the other hand, if tubes of lower conductivity, such as for example tubes made from Inconel, are used instead of the copper tubes, two short-circuiting locations are advantageous, these locations preferably being arranged at the ends of the tubes, i.e. the metal tubes in each case being short-circuited at their ends.

A further object of the invention is to produce high-purity borosilicate glasses and borate glasses with a high B₂O₃ content.

Surprisingly, it has been determined that, inter alia, the highly aggressive borosilicate glasses with a high B₂O₃ content and borate glasses even attack the metal tubes through the thin skull layer, or that reactions between the skull layer and the material of the tubes of the skull crucible may also occur. The tubes, in particular those made from metal, may also be attacked by the evaporation products and the charge batch of these glasses above the glass melt.

If extremely high demands are imposed on the optical glasses with regard to transmission, and therefore to the purity of the melt, particularly when melting borosilicate glasses and borate glasses with a high B₂O₃ content, it is advantageous if the water-cooled metal tubes comprise tubes made from platinum, a platinum alloy or aluminum, or the tubes, such as for example tubes made from copper, brass or Inconel, are coated with platinum or a platinum alloy.

For the glasses and materials which have been melted in accordance with the invention, it has also proven suitable for the tubes to be coated with plastic, preferably with a fluorine-containing plastic, since the fluorine-containing layers are not attacked even by very aggressive glasses, as has been demonstrated in DE 100 02 019, the content of disclosure of which is also hereby incorporated in its entirety in the subject of the present invention.

The batches used for the borosilicate glasses with a high B₂O₃ content and borate glasses have a very strong tendency to dusting. The high level of dusting is highly undesirable with regard to environmental protection. The strong dusting of individual components, however, also leads to fluctuations in the refractive index which cannot be adequately compensated for by subsequent correction of the batch.

According to the invention, the dusting of the batch can be greatly suppressed if the batch is added in the form of pellets.

Although the pelletizing of a batch is known in the glass industry, the objective for pelletizing in industrial tank furnaces is to recover the heat from the melting furnace. In general, in industrial grade glasses there are no great problems with regard to dusting.

The use of pellets is still a hotly debated issue in the glass industry, since in most cases the costs of pelletizing are not worthwhile.

Surprisingly, however, the inventors have discovered that in the case of a batch which substantially comprises oxides or silicates, the pellets can be stirred directly into the glass melt. Stirring the pellets directly into the glass melt makes it possible to reduce the level of dusting during melting of the batch to a massive extent. The great reduction in the dusting during melting in a skull crucible is attributed to the fact that the pellets enter the glass melt very quickly, on account of the very high convection in the skull crucible, and are thereby surrounded by the glass melt.

Furthermore, it has surprisingly been discovered that the use of pellets instead of a loose batch, in addition to reducing the dusting, also significantly shortens the melting time and thereby allows the throughput to be significantly increased. This also means that the evaporation of highly volatile components, resulting in disadvantageous stoichiometric changes during the production process, can be reduced on account of the shorter residence time of the melting material in the appliance. In the event of very high demands with regard to homogeneity, extensive evaporation of components from the melt should be substantially suppressed, and consequently the use of pellets is also advantageous in particular for the production of high-grade glasses, such as for example optical glasses.

A further increase in the throughput can advantageously be achieved by the melt being stirred while the batch is being melted down. This may, for example, be carried out in a melting section of a skull crucible.

A good stirring action can in particular also be achieved by a gas being blown into the melt. In this way, the melt can be stirred without contact, so that introduction of foreign ions or reactions with the surface of a stirrer are avoided.

For example, a bubbling tube can be introduced or inserted into the melt in the appliance, such as for example into a skull crucible, and a gas can be blown into the melt through a nozzle of the bubbling tube. However, when gas is being introduced into the melt, attention should be paid to what chemical reactions may occur. If oxygen-containing gas is introduced, the glass melt may be partially oxidized.

The process according to the invention may advantageously also encompass refining of the melting material in order to prevent bubbles in the material produced in accordance with the invention. To carry out the process according to the invention, the batch can be melted either discontinuously or continuously in the appliance.

Particularly in the case of continuous melting, the melting of the batch and the refining can be carried out either in the same crucible or in at least two crucibles or appliances connected in series. It is preferable to use skull crucibles, since they allow the batch to be melted in material of the same type, so that particularly pure materials can be produced.

Heating using high frequency produces a strong temperature gradient between the wall region and the center of a crucible, in particular a skull crucible. This temperature gradient produces an upwardly directed flow, leading to convection in the melt, so that the melt is drawn downward in the edge region close to the walls. This also advantageously allows both the melting of the batch and the refining to be carried out in particular in one skull crucible. During the downward movement, the batch is melted, and it is then refined during the upward flow.

Particularly in the case of glasses which are relatively difficult to melt or in order to achieve higher throughputs, it is expedient to use two separate crucibles or appliances for the melting and refining. Since the stronger chemical attack takes place during melting, at least the melting crucible should be a skull crucible. If the demands on purity are very high, the refining crucible may also comprise a skull crucible. It is possible for two skull crucibles to be connected in series.

With the process according to the invention, it is also possible to produce lanthanum borosilicate glasses. These glasses are also known as lanthanum crown, lanthanum flint or lanthanum dense flint glasses. The glasses produced in accordance with the invention are distinguished over known glasses, in terms of their optical properties, in particular by a significantly improved transmission, and moreover can be produced at lower costs using the process.

Since all computer programs used to calculate special lens systems are matched to commercially available glasses and their properties, it is advantageous, when producing glasses for lens systems of this type in accordance with the invention, for the composition of these glasses to be selected in such a way that the optical properties, such as refractive index and dispersion, coincide with those of commercially available glasses.

In addition to the glass structure, the network modifiers also play an important role with regard to the coupling behavior. The divalent and trivalent metal oxides are most important for the coupling behavior. According to one embodiment of the invention, the composition of the melting material is advantageously selected in such a way that the concentration of divalent and trivalent metal oxides, or the quantitative proportion thereof in the melting material, is at least 25 mol %.

Whereas in the case of the borate glasses and the crystallizing borate-containing materials the total Al₂O₃, Ga₂O₃, and In₂O₃ content may amount to 25%, in particular in the case of borosilicate glasses with a high B₂O₃ content the total content of the network formers Al₂O₃, Ga₂O₃, and In₂O₃ should not exceed 10%.

According to one embodiment of the process according to the invention, a borate-containing, low-alkali material, such as in particular a low-alkali or alkali-free borosilicate glass with a high boric acid content or a borate glass or a crystallizing borate-containing material, is produced, and to produce the material a composition is selected for the borate-containing melting material in which:
B₂O₃ 15 to 75 mol %,
SiO₂ 0 to 40 mol %,
Al₂O₃, Ga₂O₃, In₂O₃ 0 to 25 mol %,
ΣM(II)O, M₂(III)O₃ 15 to 85 mol %,
ΣM(IV)O₂, M₂(V)O₅, M(VI)O₃ 0 to 20 mol %, and
ΣM(I)₂O less than 0.50 mol %
are present, and in which
X(B₂O₃) is >0.50,
where
X(B₂O₃)=B₂O₃/(B₂O₃+SiO₂),
M(I)=Li, Na, K, Rb, Cs,
M(II)=Mg, Ca, Sr, Ba, Zn, Cd, Pb, Cu,
M(III)=Sc, Y, ⁵⁷La—⁷¹Lu, Bi,
M(IV)=Ti, Zr, Hf,
M(V)=Nb, Ta,
M(VI)=Mo, W.

In this context, the sum indicator “Σ” denotes the sum of all the quantitative proportions listed after the sum indicator. The percentages are quantitative proportions in mol %. Furthermore, X(B₂O₃)=B₂O₃/(B₂O₃+SiO₂) denotes the quantitative mole fraction of the network formers B₂O₃ with respect to SiO₂.

Further oxides of the elements of the periodic system (Ge, P, Sn, colored oxides), as well as refining agents in the standard quantities, are possible depending on the particular application but not essential for the properties of the material and the coupling ability of the melt.

Within this composition range, in particular to produce vitreous materials, such as borosilicate glasses with a high boric acid content or borate glasses, the composition of the melt is advantageously selected in such a way that the quantitative proportion of B₂O₃ is 15 to 75 mol % and the mole fraction X(B₂O₃) is >0.52. It is particularly preferable for the composition of the melting material if the B₂O₃ content is selected to be in the range between 20 and 70 mol %, the Σ M(II)O, M₂(III)O₃ content, i.e. the sum of the quantitative proportions of oxides with divalent and trivalent metal ions, is selected to be in the range between 15 and 80 mol %, and X(B₂O₃) is selected to be >0.55.

Furthermore, within the ranges given above for compositions of the boron-containing melting material, a composition range in which in the melting material the content of
B₂O₃ is 28 to 70 mol %, the content of
B₂O₃+SiO₂ is 50 to 73 mol %, the content of
Al₂O₃, Ga₂O₃, In₂O₃ is 0 to 10 mol %, and the content of
ΣM(II)O, M₂(III)O₃ is 27 to 50 mol %, and
X(B₂O) is >0.55,
   is particularly advantageous for the optical properties of the glasses.

In this context, to produce borosilicate glasses with a high boric acid content and borate glasses, it is particularly preferable to select a composition of the melting material in which:
B₂O₃ 36 to 66 mol %,
SiO₂O to 40 mol %,
B₂O₃+SiO₂ 55 to 68 mol %,
Al₂O₃, Ga₂O₃, In₂O₃ 0 to 2 mol %,
ΣM(II)O, M₂(III)O₃ 27 to 40 mol %, and
ΣM(IV)O₂, M₂(V)O₅, M(VI)O₃ 0 to 15 mol % are present, and
X(B₂O₃) is >0.65.

According to a further embodiment of the invention, which is particularly suitable for the production of borosilicate glasses with a high boric acid content and borate glasses for optical applications, the composition of the melting material is selected in such a way that the quantitative proportions are:
B₂O₃ 45 to 66 mol %,
SiO₂O to 12 mol %,
B₂O₃+SiO₂ 55 to 68 mol %,
Al₂O₃, Ga₂O₃, In₂O₃ 0 to 0.5 mol %,
ΣM(II)O 0 to 40 mol %,
ΣM₂(III)O₃ 0 to 27 mol %,
ΣM(II)O, M₂(III)O₃ 27 TO 40 mol %, and
   ΣM(IV)O₂, M₂(V)O₅, M(VI)O₃ 0 to 15 mol %. In this case, the quantitative proportions of B₂O₃ and SiO₂ are, moreover, selected in such a way that X(B₂O₃) is >0.78. In this variant of the process, the divalent metal ions, M(II), added are in particular Mg, Ca, Sr, Ba, Zn, Cd, Pb. Furthermore, the transmission of the optical glasses obtained in this way can be improved if the melting material does not contain any strongly coloring CuO. The network modifiers PbO and CdO are known to have a toxic action. It is therefore advantageous and in some cases even a statutory requirement to dispense with these components in the composition of the melt and to select compositions which are free of PbO and CdO.

If a composition of the melting material in which
B₂O₃ 30 to 75 mol %,
SiO₂ <1 mol %,
Al₂O₃, Ga₂O₃, In₂O₃ 0 to 25 mol %,
ΣM(II)O, M₂(III)O₃ 20 to 85 mol %, and
   ΣM(IV)O₂, M₂(V)O₅, M(VI)O₃ 0 to 20 mol % are present, and in which the ratio of the quantities of borate and silicon oxide is selected in such a way that X(B₂O₃) is >0.90, is selected, it is possible, for example, to produce not only borate glasses but also crystallizing boron-containing materials, such as in particular glass-ceramics, using this embodiment of the process according to the invention.

According to a further embodiment of the process, which is suitable in particular for the production of crystallizing boron-containing materials, such as for example glass-ceramics, a composition is selected for the melting material in which the quantitative proportions are
B₂O₃ 20 to 50 mol %,
SiO₂ 0 to 40 mol %,
Al₂O₃, Ga₂O₃, In₂O₃ 0 to 25 mol %,
ΣM(II)O, M₂(III)O₃ 15 to 80 mol %, and
ΣM(IV)O₂, M₂(V)O₅, M(VI)O₃ 0 to 20 mol %, and
in which X(B₂O₃) is >0.52.

To achieve good coupling, in this embodiment of the process according to the invention the composition of the melting material may advantageously be selected in such a way that X(B₂O₃) is >0.55.

In this case, the coupling of a melt of this type can be improved further if the quantitative proportions are
ΣM(II)O 15 to 80 mol %, and
M₂(III)O₃ 0 to 5 mol %, in the melting material, and
X(B₂O₃) is >0.60.

According to yet another advantageous variant of this process, the quantitative proportion of substances selected from the group consisting of Al₂O₃, Ga₂O₃, and In₂O₃ is also selected in such a way that it does not exceed 5 mol %.

A variant of this embodiment of the process according to the invention in which the quantitative proportion of substances selected from the group consisting of Al₂O₃, Ga₂O₃, and In₂O₃ does not exceed 3 mol % and in which the quantitative proportion of ΣM(II)O in the melt is in the range from 15 to 80 mol %, with M(II) being selected from a group consisting of Zn, Pb, and Cu, is particularly preferred. In this case, moreover, the composition of the melt is selected in such a way that X(B₂O₃) is >0.65.

According to a further embodiment, a composition is selected for the melting material in which the quantitative proportions are
B₂O₃ 20 to 50 mol %,
SiO₂ 0 to 40 mol %,
Al₂O₃ 0 to 3 mol %,
ΣZnO, PbO, CuO 15 to 80 mol %,
Bi₂O₃ 0 to 1 mol %, and
   ΣM(IV)O₂, M₂(V)O₅, M(VI)O₃ 0 to 0.5 mol %. In this embodiment, moreover, the composition is selected in such a way that X(B₂O₃) is >0.65.

According to a preferred variant of this embodiment of the process, the following quantitative proportions are selected:
B₂O₃ 20 to 50 mol %,
SiO₂ 0 to 40 mol %,
Al₂O₃ 0 to 3 mol %,
ΣZnO, PbO, CuO 15 to 80 mol %,
Bi₂O₃ 0 to 1 mol %, and
ΣM(IV)O₂, M₂(V)O₅, M(VI)O₃ 0 to 0.5 mol %.

In this case, the quantitative proportions of borate and silicon oxide are advantageously selected in such a way that X(B₂O₃) is >0.65.

The invention is explained in more detail below with reference to a number of examples.

### EXAMPLE 1

For the coupling tests, the glasses were tested in a 30 l skull crucible. For this purpose, the batch was introduced into the skull crucible and melted using a burner. After melting, the high frequency is switched on and the burner switched off. The glass melt is then heated further using the high frequency. If the glass melt can be heated to higher temperatures, the glass is coupled to the high frequency.

If this is not possible or if the high frequency is not successfully coupled in, so that the glass melt cools again, the glass melt is considered not to be capable of coupling.

If the glass melt is decoupled, the amount of heat emitted by the skull crucible and the glass surface is greater than the energy coupled in by the high frequency.

Table 1 shows examples of borosilicate glasses with a high B₂O₃ content and borate glasses which do not couple.

TABLE 1
Non-coupling glasses, details in mol %.

| | Glass | | | | |
|---|---|---|---|---|---|
| Oxide | 1 | 2 | 3 | 4 | 5 |
| B₂O₃ | 18 | 25 | 32.5 | 28 | 80 |
| SiO₂ | 60 | 52 | 44.5 | 32.5 | — |
| Al₂O₃ | 2 | 2.5 | 2.5 | — | — |
| PbO | 20 | 20.5 | 20.5 | — | — |
| La₂O₃ | — | — | — | 4.5 | — |
| BaO | — | — | — | 34.4 | 20 |
| TiO₂ | — | — | — | — | — |
| ZrO₂ | — | — | — | 0.4 | — |
| WO₃ | — | — | — | 0.04 | — |
| Sb₂O₃ | — | — | — | 0.06 | — |
| Sum | 100 | 100 | 100 | 100 | 100 |
| B₂O₃/ | 0.23 | 0.32 | 0.42 | 0.46 | 1.00 |
| B₂O₃ + SiO₂ | | | | | |

In the non-coupling glasses 1 to 4, the quantitative ratio of borate to silicon oxide is less than 0.5. Accordingly, in these glasses silicon oxide is the dominant network former. Inductive coupling of these melts to the high-frequency field in the skull crucible is not possible on account of the fact that alkali metal ions are not present or are only present in small amounts and on account of this quantitative ratio of borate, B₂O₃, to silicon oxide, SiO₂. Although in the case of glass 5 in Table 1 borate is the only network former, the quantitative proportion of metal oxide whose metal ions have a valency of at least two is only 20%. This also means that the conductivity of the melt is insufficient for coupling in a skull crucible.

In Table 2, Examples 6 to 8 are limit cases for borosilicate and borate glasses with a high B₂O₃ content, in which the experimental conditions have to be selected very carefully in order still to achieve coupling. For example, a temperature of >1300° C., a high voltage at the coil which induces the high frequency and a sufficient power of the high-frequency generator are required in order for a sufficient amount of energy to be coupled in. On the other hand, the temperature should not be selected to be too high, in order to prevent B₂O₃ from evaporating. This means that the process window for these glasses may be very narrow.

TABLE 2
limit cases for coupling glasses (details in mol %)

| | Glass | | |
|---|---|---|---|
| Oxide | 6 | 7 | 8 |
| B₂O₃ | 75 | 34 | 40 |
| SiO₂ | | 32 | 36.5 |
| Al₂O₃ | | — | 2.5 |
| PbO | | — | 21 |
| La₂O₃ | | 2 | — |
| BaO | 25 | 31 | — |
| ZrO₂ | | 0.9 | — |
| Sb₂O₃ | | 0.1 | — |
| Sum | | 100 | 100 |
| B₂O₃/ | 1.00 | 0.52 | 0.52 |
| B₂O₃ + SiO₂ | | | |

Table 3 gives examples of borosilicate glasses and borate glasses with a high B₂O₃ content which can be coupled to high frequency without problems and can be melted in a skull crucible.

TABLE 3
Coupling glasses (details in mol %)

| | Glass | | | | | | | | | |
|---|---|---|---|---|---|---|---|---|---|---|
| Oxide | 9 | 10 | 11 | 12 | 13 | 14 | 15 | 16 | 17 | 18 |
| B₂O₃ | 34 | 26 | 22.5 | 40 | 52 | 60 | 65.5 | 50 | 62 | 31.7 |
| SiO₂ | — | 12.6 | 9 | 36.5 | 11.5 | 4 | — | 9 | — | — |
| Al₂O₃ | — | — | 2 | 2.5 | — | — | — | — | — | 13.9 |
| PbO | 66 | 1 | 23.5 | 21 | — | — | — | — | — | — |
| ZnO | — | 60 | 36 | — | 5 | 7.5 | — | 5 | — | — |
| La₂O₃ | — | — | — | — | 18.5 | 13.5 | — | 20 | — | — |
| Y₂O₃ | — | — | — | — | 4.5 | — | — | 5.5 | — | — |
| CaO | — | — | — | — | — | 11 | 21 | — | — | — |
| BaO | — | — | — | — | — | — | — | — | 38 | 48.8 |
| TiO₂ | — | — | — | — | 0.5 | — | — | — | — | — |
| ZrO₂ | — | — | — | — | 8 | 4 | 1.5 | 9 | — | 5.6 |
| Nb₂O₅ | — | — | — | — | — | — | — | 1 | — | — |
| Ta₂O₅ | — | — | — | — | — | — | — | 0.5 | — | — |
| Nd₂O₃ | — | — | — | — | — | — | 9 | — | — | — |
| Pr₂O₃ | — | — | — | — | — | — | 3 | — | — | — |
| CuO | — | — | 7 | — | — | — | — | — | — | — |
| CeO₂ | — | 0.25 | — | — | — | — | — | — | — | — |
| As₂O₃ | — | — | — | — | — | — | 0.02 | — | — | — |
| Sb₂O₃ | — | 0.15 | — | — | 0.04 | 0.02 | — | 0.05 | — | — |
| Sum | 100 | 100 | 100 | 100 | 100.04 | 100.02 | 100.02 | 100.05 | 100 | 100 |
| B₂O₃/ | 1.00 | 0.67 | 0.71 | 0.52 | 0.82 | 0.94 | 1.00 | 0.85 | 1.00 | 1.00 |
| B₂O₃ + SiO₂ | | | | | | | | | | |

### EXAMPLE 2

By way of example, the improvement in the light transmission brought about by the use of the skull melting technique in combination with the high-frequency heating compared to the conventional melt in a platinum crucible is demonstrated on the basis of the glass 14 in Table 3, which is capable of coupling.

An optical glass from the family of lanthanum borosilicate glasses was melted in a stainless steel skull crucible coated with platinum. The following melting parameters were used:

Charging: 1240-1260° C.

Refining: 1280° C.

Standing off: 1240-1200° C.

Casting: approx. 1200° C. in the crucible; approx. 1100° C. in the feeder.

The melt was cast into molds of various geometries (panes, rods, bars) and cooled from 650° C. to room temperature.

The following values were measured:

nd = 1.71554; (1.71300)
vd = 53.41; (53.83)
ΔPg,F = −0.0084; (−0.0083)
τi (400 nm; 25 mm) = 0.972; (0.94).

Here, nd denotes the refractive index at the Fraunhofer line d at λ=587.5618 nm, v_{d} is the Abbe number at this Fraunhofer line. ΔP_{g,F} corresponds to the anomaly of the relative partial dispersion P_{g,F} measured at the Fraunhofer lines g and F. τi denotes the net transmittance.

The reference values given in parentheses were measured on a glass of the same composition which has been melted using conventional melting technology, i.e. in an induction-heated platinum crucible.

The improvement can be recognized from the fact that the net transmittance has risen significantly in the blue spectral region. Absorptions in the blue region cause a yellowing color cast, so that for observation applications, such as photography, microscopy and telescopes, the minimum possible absorption is desired. The deviations in refractive index and Abbe number are caused by the slightly higher dusting rate of the new technology and can easily be corrected by fine-tuning the batch or by using pellets instead of loose batch.

A continuous melting test using the same glass under the following melting conditions:

Melting in a high-frequency-heated skull crucible at 1280° C. After refining in a platinum refining chamber at 1400° C., the following values resulted:

nd = 1.70712; (1.71300)
vd = 53.68; (53.83)
ΔPg,F = −0.0084; (−0.0084)
τi (400 nm; 25 mm) = 0.965; (0.94)
τi (365 nm; 25 mm) = 0.831; (0.72).

The reference values given in parentheses, as above, relate to measured values on a glass of the same composition which has been melted using an induction-heated platinum crucible.

In this case, the transmission value at 365 nm, which is characteristic of many UV applications, was also determined. This wavelength corresponds to an important emission line of Hg vapor lamps which is used for many applications. In a glass produced in accordance with the invention, the light yield at this wavelength can be increased by 0.111 or 15% compared to a glass which is known from the prior art, leading to a considerable product advantage. Furthermore, the possibilities for corrective measures referred to above can be recognized from the deviation in refractive index toward lower values.

The components B₂O₃ and Ln₂O₃ (Ln=Sc, Y, La, Gd, Yb, Lu) are characteristic of the glasses in accordance with Example 2. They can be varied within a wide concentration range. All other components are optional and may be supplemented by further components. In this way, it is possible to produce optical glasses belonging to the lanthanum crown, lanthanum flint and lanthanum dense flint classes within a wide range of refractive indices and Abbe numbers.

### EXAMPLE 3

A melt of the glass 8 from Table 2 with coupling ability is used to demonstrate that the distances between the water-cooled metal tubes should be <4 mm, preferably <3.5 mm, in order to prevent the glass melt from running out.

A batch was introduced into a 10 liter skull crucible, the metal tubes of which were spaced apart by at most 4.5 mm, and was melted initially using a burner. After the initial batch had been melted, the high frequency was switched on and the burner switched off. From then on, the batch was melted exclusively by the use of high frequency. Once the skull crucible was approximately three quarters full of glass melt, the glass melt broke through. The glass melt ran out very quickly between two water-cooled metal tubes.

A second test used a skull crucible whose metal tubes were spaced apart by 3.5 mm. The test was repeated as described above. It was possible to fill the skull crucible with molten batch without problems and without the glass melt escaping.

### EXAMPLE 4

The appended figure shows a diagram which represents the change in the conductivity of a melt having a melting material composition in which the ratio of the molar quantities of silicon dioxide to borate in the melting material is less than 0.5. The current passing through the melt and the voltage applied in order to produce the current were measured. The measured values are plotted as a function of the quantitative proportion of BaO, i.e. a metal oxide with divalent metal ions.

It can be seen from the diagram that there is a sudden increase in the current passing through the melt at a BaO quantitative proportion of 25 mol %. Above this quantitative proportion there is then also a considerable drop in the voltage required to produce this current, and therefore a further increase in the conductivity of the melt. On account of this effect, which is shown by way of example for BaO in the figure, it is possible, according to the invention, beyond a quantitative proportion of divalent or polyvalent metal oxides of 25% or more, to couple up even melts in which the ratio of the molar quantities of silicon dioxide to borate in the melting material is less than 0.5.

1. A process for producing a borate-containing, low-alkali material, comprising:
induction-heating a boron-containing melting material directly in an appliance using an alternating electromagnetic field, wherein the boron-containing melting material includes at least one metal oxide, having metal ions of with a valency of at least two, the at least one metal oxide being in a quantitative proportion of at least 25 mol %, and the boron-containing melting material having a ratio of the molar substance quantities of silicon dioxide to borate of less than or equal to 0.5.

2. The process as claimed in claim 1, wherein the alternating electromagnetic field is a high-frequency field.

3. The process as claimed in claim 1, wherein the alternating electromagnetic field has a frequency in the range from 50 kHz to 1500 kHz.

4. The process as claimed in claim 1, wherein the boron-containing, melting material comprises a borate-containing material, a borate glass, or a borosilicate glass with a high boric acid content.

5. The process as claimed in claim 1, wherein the boron-containing melting material comprises a quantitative proportion of alkali-containing compounds of less than 2%.

6. The process as claimed in claim 1, wherein the appliance comprises a skull crucible in which the boron-containing melting material is melted.

7. The process as claimed in claim 6, wherein skull crucible has walls that comprises cooled tubes that are spaced apart from one another by a spacing of between 2 mm and 4 mm.

8. The process as claimed in claim 7, wherein the cooled tubes of the skull crucible are short-circuited in the region of a high-frequency coil for emitting the alternating electromagnetic field.

9. The process as claimed in claim 8, wherein the cooled tubes are short-circuited at, in each case, one location.

10. The process as claimed in claim 8, wherein the cooled tubes are, in each case, short-circuited at their ends.

11. The process as claimed in claim 7, wherein the cooled tubes comprise tubes made from platinum, a platinum alloy or aluminum.

12. The process as claimed in claim 7, wherein the cooled tubes are coated with a layer of platinum or a platinum alloy.

13. The process as claimed in claim 7, wherein the cooled tubes are coated with fluorine-containing plastic.

14. The process as claimed in claim 1, further comprising adding a batch in the form of pellets to the appliance.

15. The process as claimed in claim 1, further comprising stirring the boron-containing melting material during the induction-heating.

16. The process as claimed in claim 1, further comprising blowing a gas into the the boron-containing melting material.

17. The process as claimed in claim 16, further comprising introducing a bubbling tube into the boron-containing melting material and blowing the gas into the boron-containing melting material through a nozzle of the bubbling tube.

18. The process as claimed in claim 1, further comprising refining the boron-containing melting material.

19. The process as claimed in claim 18, wherein the boron-containing melting material is melted and refined in at least two appliances connected in series.

20. The process as claimed in claim 18, wherein the boron-containing melting material is melted and refined in the same appliance.

21. The process as claimed in claim 1, further comprising discontinuously melting the boron-containing melting material in the appliance.

22. The process as claimed claim 1, further comprising continuously melting the boron-containing melting material in the appliance.

23. A melting material for producing a borate-containing, low-alkali material, comprising:
B₂O₃ 15 to 75 mol %,
SiO₂ 0 to 40 mol %,
Al₂O₃, Ga₂O₃, In₂O₃ 0 to 25 mol %,
ΣM(II)O, M₂(III)O₃ 15 to 85 mol %,
ΣM(IV)O₂, M₂(V)O₅, M(VI)O₃ 0 to 20 mol %, and
ΣM(I)₂O is less than 0.50 mol %, and wherein
X(B₂O₃) is greater than 0.50, where
X(B₂O₃)=B₂O₃/(B₂O₃+SiO₂),
M(I)=Li, Na, K, Rb, Cs,
M(II)=Mg, Ca, Sr, Ba, Zn, Cd, Pb, Cu,
M(III)=Sc, Y, ⁵⁷La—⁷¹Lu, Bi,
M(IV)=Ti, Zr, Hf,
M(V)=Nb, Ta, and
M(VI)=Mo, W.

24. The melting material as claimed in claim 23, wherein X(B₂O₃) is greater than 0.52.

25. The melting material as claimed in claim 23, wherein
B₂O₃ is 20 to 70 mol %,
the content of ΣM(II)O, M₂(III)O₃ is 15 to 80 mol %, and
X(B₂O₃) is greater than 0.55.

26. The melting material as claimed in claim 23, wherein
B₂O₃ is 28 to 70 mol %,
the content of B₂O₃+SiO₂ is 50 to 73 mol %,
the content of Al₂O₃, Ga₂O₃, In₂O₃ is 0 to 10 mol %, and
the content of ΣM(11)O, M₂(III)O₃ is 27 to 50 mol %, and
X(B₂O₃) is greater than 0.55.

27. The melting material as claimed in claim 26, wherein
B₂O₃ is 36 to 66 mol %,
SiO₂ is 0 to 40 mol %,
B₂O₃+SiO₂ is 55 to 68 mol %,
Al₂O₃, Ga₂O₃, In₂O₃ is 0 to 2 mol %,
ΣM(II)O, M₂(III)O₃ is 27 to 40 mol %,
ΣM(IV)O₂, M₂(V)O₅, M(VI)O₃ is 0 to 15 mol %, and
X(B₂O₃) is greater than 0.65.

28. The process as claimed in claim 1, wherein the borate-containing, low-alkali material is useful for the production of borate glasses and borosilicate glasses with a high boric acid content for optical applications, the boron-containing melting material comprising:
B₂O₃ 45 to 66 mol %,
SiO₂ 0 to 12 mol %,
B₂O₃+SiO₂ 55 to 68 mol %,
Al₂O₃, Ga₂O₃, In₂O₃ 0 to 0.5 mol %,
ΣM(II)O 0 to 40 mol %,
ΣM₂(III)O₃ 0 to 27 mol %,
ΣM(II)O, M₂(III)O₃ 27 to 40 mol %,
ΣM(IV)O₂, M₂(V)O₅, M(VI)O₃ 0 to 15 mol %, and wherein
X(B₂O₃) is greater than 0.78, where
M(II)=Mg, Ca, Sr, Ba, Zn, Cd, Pb.

29. The process as claimed in claim 1, wherein the borate-containing, low-alkali material is useful for the production of borate glasses and crystallizing boron-containing materials, the boron-containing melting material comprising:
B₂O₃ 30 to 75 mol %,
SiO₂ less than 1 mol %,
Al₂O₃, Ga₂O₃, In₂O₃ 0 to 25 mol %,
ΣM(II)O, M₂(III)O₃ 20 to 85 mol %, and
ΣM(IV)O₂, M₂(V)O₅, M(VI)O₃ 0 to 20 mol %, and wherein
X(B₂O₃) is greater than 0.90.

30. The process as claimed in claim 1, wherein the borate-containing, low-alkali material is useful for producing crystallizing borate-containing material, the boron-containing melting material comprising:
B₂O₃ 20 to 50 mol %,
SiO₂ 0 to 40 mol %,
Al₂O₃, Ga₂O₃, In₂O₃ 0 to 25 mol %,
ΣM(II)O, M₂(III)O₃ 15 to 80 mol %, and
ΣM(IV)O₂, M₂(V)O₅, M(VI)O₃ 0 to 20 mol %, and wherein
X(B₂O₃) is greater than 0.52.

31. The process as claimed in claim 30, wherein X(B₂O₃) is greater than 0.55.

32. The process as claimed in claim 30, wherein the quantitative proportions are
ΣM(II)O 15 to 80 mol %, and
M₂(III)O₃ 0 to 5 mol %, and
X(B₂O₃) is greater than 0.60.

33. The process as claimed in claim 30, wherein the quantitative proportion of substances selected from a group consisting of Al₂O₃, Ga₂O₃ and In₂O₃ does not exceed 5 mol %.

34. The process as claimed in claim 30, wherein the quantitative proportion of substances selected from a group consisting of Al₂O₃, Ga₂O₃ and In₂O₃ does not exceed 3 mol %, and in which the quantitative proportion of ΣM(II)O is in the range from 15 to 80 mol %, and in which X(B₂O₃) is greater than 0.65, where M(II)=Zn, Pb, Cu.

35. The process as claimed in claim 1, wherein the boron-containing melting material comprises:
B₂O₃ 20 to 50 mol %,
SiO₂ 0 to 40 mol %,
Al₂O₃ 0 to 3 mol %,
ΣZnO, PbO, CuO 15 to 80 mol %,
Bi₂O₃ 0 to 1 mol %, and
ΣM(IV)O₂, M₂(V)O₅, M(VI)O₃ 0 to 0.5 mol %, and wherein
X(B₂O₃) is greater than 0.65.

36. The process as claimed in claim 35, wherein
B₂O₃ is 20 to 42 mol %,
SiO₂ is 0 to 38 mol %,
ΣZnO, PbO is 20 to 68 mol %,
CuO is 0 to 10 mol %,
ΣZnO, PbO, CuO is 20 to 68 mol %, and
Bi₂O₃ is 0 to 0.1 mol %, and wherein
X(B₂O₃) is greater than 0.65.

37. The process as claimed in claim 1, wherein the boron-containing melting material is free of PbO and CdO .
